(19) United States
(12) Patent Application Publication
(10) Pub. No.: US 2008/0203594 A1
(43) Pub. Date: Aug. 28, 2008

(54) METHOD FOR FABRICATING AERATION STONE

(76) Inventors: Cheng-Nan CHANG, Taichung City (TW); Wen-fang Su, Jhunan Township (TW)

Correspondence Address: SINORICA, LLC, 528 FALLSGROVE DRIVE, ROCKVILLE, MD, 20850, US

(21) Appl. No.: 11/955,457

(22) Filed: Dec. 13, 2007

(30) Foreign Application Priority Data
Feb. 27, 2007 (TW) 96106655

(51) Int. Cl. B29C 67/00; B29C 35/02; B29C 35/16

(52) U.S. Cl. 264/28; 264/80

(57) ABSTRACT

A method for fabricating an aeration stone is disclosed, which abandoned activated sludge, red soil and an alkaline metal oxide are separately dried firstly and then cracked, and next the cracked abandoned activated sludge, red soil and alkaline metal oxide are separately sieved to obtain smaller grains thereof, and then the grains are separately ground into fine particles thereof and are mixed to be a mixture. Next, the mixture is molded into a green aeration stone. Next, the green aeration stone is fired at a high temperature and then cooled down to obtain a finished aeration stone. Therefore, the present invention recycles the abandoned sludge of wastewater treatment works to reduce the secondary pollution of abandoned sludge.

### BACKGROUND OF THE INVENTION

1. Field of the Invention

The present invention relates to a method for fabricating an aeration stone, particularly to a method for fabricating an aeration stone via firing abandoned activated sludge.

2. Description of the Related Art

The activated sludge process has been used in wastewater treatment for many years, wherein varied organic matter in wastewater is decomposed by the metabolism of microorganisms under an oxygen-bearing environment. With the increase of wastewater, the abandoned sludge also increases persistently, which results in problems in the succeeding treatment, including the cost of wastewater treatment works and secondary environmental pollution.

Therefore, how to reduce, stabilize, disarm and recycle abandoned sludge has been the focus of wastewater treatment. From the related literatures, it is known that abandoned sludge can be fired into a lightweight aggregate; for example, abandoned sludge may be mixed with another material, such cement or pitch, and then the mixture is fired into the lightweight aggregate for building or pavement, such as bricks or titles.

Further, it is also found that abandoned sludge can be fabricated into an aeration stone, which benefits resource recycling. Contrarily, some manufactures fire silica materials into oxidation-resistant aeration stones at a temperature of 1200° C. However, such a technology needs a higher equipment investment. Further, the conventional technology still adopts new material to fabricate aeration stones, which is without the efficacy of resource recycling. A Taiwan patent No. 171700 disclosed an “Air Injection Device”, wherein the aeration stone is a diffuser with honeycombed pores and made of a flexible or semi-flexible foaming material, such as a polyether-based foam. This conventional technology also needs new material. Further, the abandoned aeration stone thereof becomes new trash.

Accordingly, the present invention proposes a method of utilizing abandoned sludge to fabricate an aeration stone to solve the abovementioned problems.

### SUMMARY OF THE INVENTION

One objective of the present invention is to provide a method for fabricating an aeration stone, wherein the abandoned sludge of wastewater treatment works is recycled and used as the main material of aeration stones.

Another objective of the present invention is to provide a method for fabricating an inorganic aeration stone.

According to the present invention, abandoned activated sludge, red soil and an alkaline metal oxide are separately dried firstly. Next, the abandoned activated sludge, red soil and alkaline metal oxide are cracked and sieved to obtain smaller grains thereof. Next, the grains are separately ground into the powders of very fine particles. Next, the powders of abandoned activated sludge, red soil and alkaline metal oxide are mixed. Next, the mixture is molded into a green aeration stone. Next, the green aeration stone is fired to harden and then cooled down. Thus, a porous aeration stone is attained.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

FIG. 1 is a flowchart showing the method for fabricating an aeration stone according to the present invention;

FIG. 2A is an SEM image of the grains of the abandoned activated sludge before grinding;

FIG. 2B is an SEM image of the grains of the abandoned activated sludge after grinding;

FIG. 3A is an SEM image of the grains of the red soil before grinding.

FIG. 3B is an SEM image of the grains of the red soil after grinding;

FIG. 4A is a diagram showing a heating curve of the firing process of the green aeration stone according to the present invention;

FIG. 4B is a diagram showing another heating curve of the firing process of the green aeration stone according to the present invention;

FIG. 5 is a diagram schematically showing the finished aeration stone fabricated according to the present invention;

FIG. 6 is a diagram showing the application of the aeration stone fabricated according to the present invention;

FIG. 7 is a diagram showing the dissolved-oxygen curves of a conventional aeration stone and the aeration stones fabricated according to the present invention;

FIG. 8A is a diagram showing the oxygen transference coefficient of one aeration stone fabricated according to the present invention;

FIG. 8B is a diagram showing the oxygen transference coefficient of another aeration stone fabricated according to the present invention;

FIG. 8C is a diagram showing the oxygen transference coefficient of another aeration stone fabricated according to the present invention; and

FIG. 8D is a diagram showing the oxygen transference coefficient of a conventional aeration stone.

### DETAILED DESCRIPTION OF THE INVENTION

Via the following embodiments and the attached drawings will be more easily understood the objectives, technical contents, characteristics and accomplishments of the present invention.

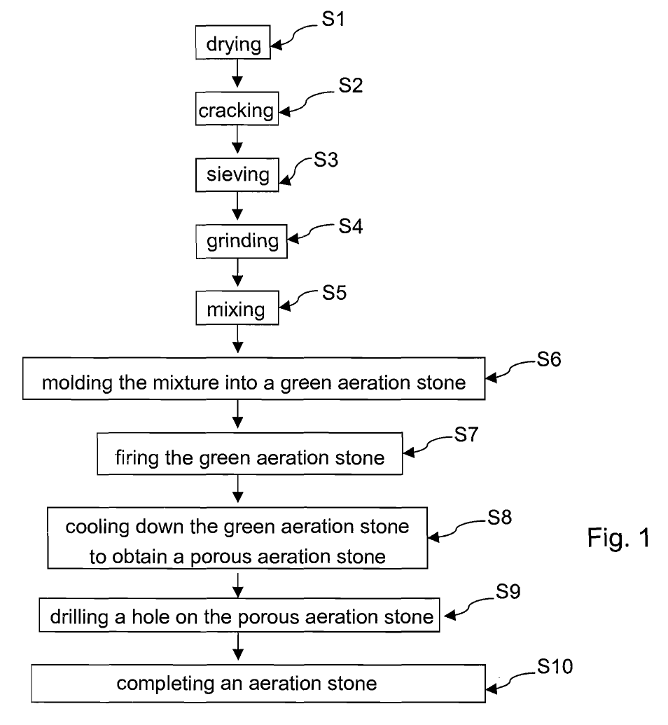

Refer to FIG. 1, which is a flowchart showing a method for fabricating an aeration stone according to the present invention. In Step S1, abandoned activated sludge, red soil and an alkaline metal oxide are separately dried firstly; for example, they are dried inside a baking oven at a temperature of between 80 to 120° C., wherein the preferably dried treatment is that the abandoned activated sludge, red soil and an alkaline metal oxide are at a temperature of over 100° C., such as 105° C., for three days. The red soil is used to increase the cohesiveness required in molding the aeration stone. The alkaline metal oxide is used as a foaming agent, such as ferric oxide (Fe₂O₃), and also used to increase hardness.

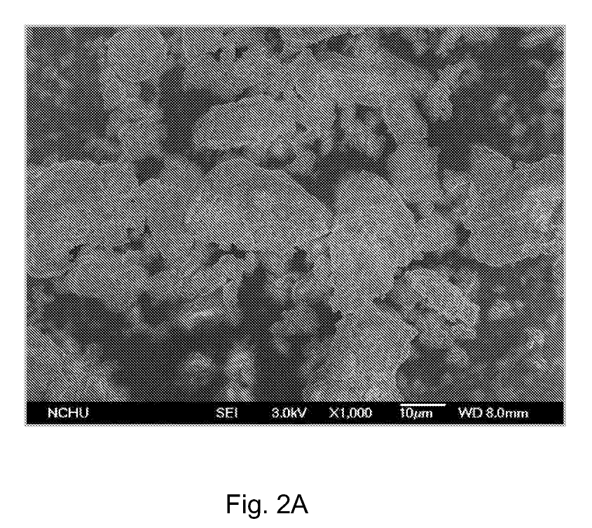

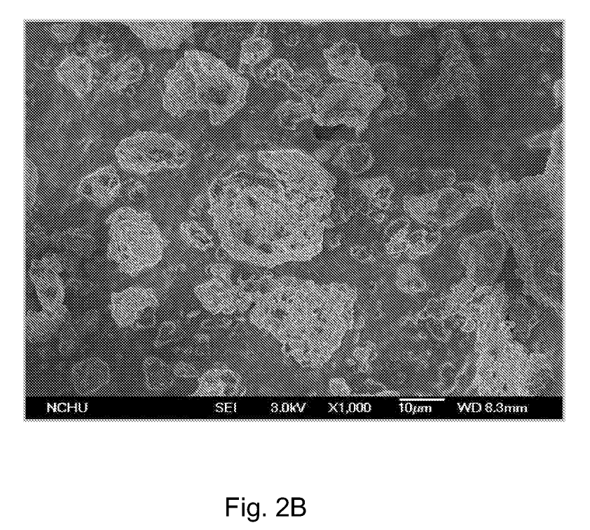

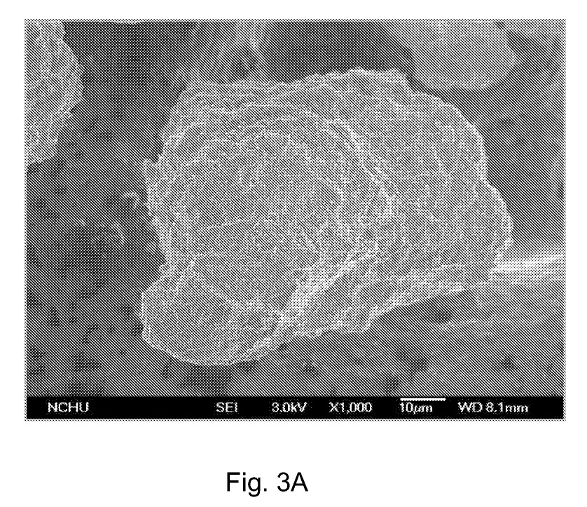

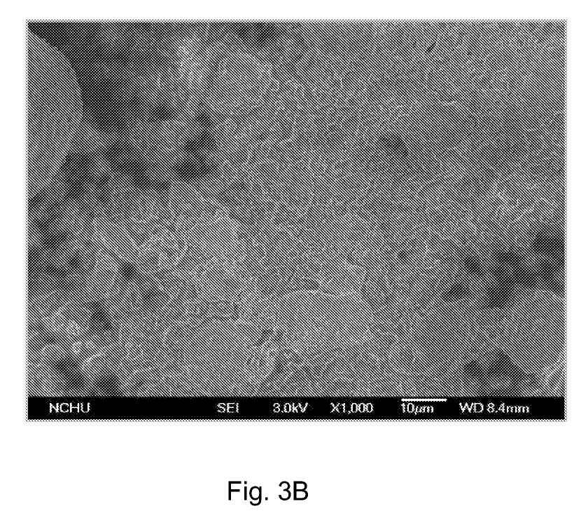

Next in Step S2, the dried abandoned activated sludge, red soil and alkaline metal oxide are separately cracked by crushers. Next in Step S3, the cracked abandoned activated sludge, red soil and alkaline metal oxide are separately sieved by sieving machines to obtain smaller grains thereof. The sieving machines can adopt a No. 50 sieve, which has a sieve diameter of 0.297 mm, to obtain grains having a diameter of about 0.297 mm. Next in Step S4, the grains of the abandoned activated sludge, red soil and alkaline metal oxide are separately ground by ball mills at a rotation speed of 8000 rpm (revolution per minute) to obtain fine particles having a diameter of less than 10 μm. Refer to FIG. 2A and FIG. 2B, which are respectively the SEM (Scanning Electron Microscope) images of the abandoned activated sludge before and after grinding. Refer to FIG. 3A and FIG. 3B, which are respectively the SEM images of the red soil before and after grinding. The finer the particles, the smaller the gaps between the particles, the compacter the structure of the molded green aeration stone, and thus the higher the strength of the molded green aeration stone.

Next in Step S5, the fine particles of the abandoned activated sludge, red soil and alkaline metal oxide are mixed by a ratio of between 5:6:1 and 5:12:1 to obtain a mixture. A small amount of water is added in the mixing process to increase the cohesiveness of the mixture. Next in Step S6, the mixture is placed in an aeration-stone mold and compressed to obtain a green aeration stone having an arbitrary shape, wherein a cylindrical shape is preferable.

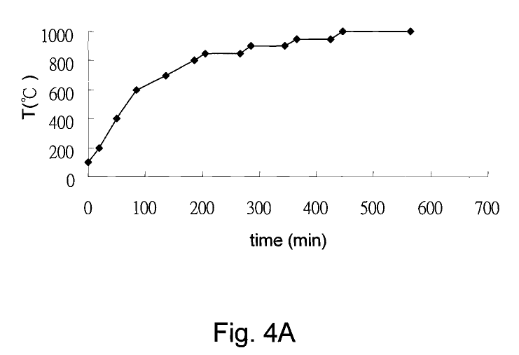

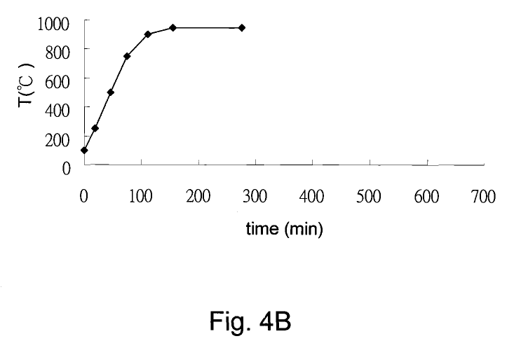

Next in Step S7, the green aeration stone is fired; the firing process includes the following steps: air drying the green aeration stone for 10 minutes; placing the green aeration stone inside a freezing device for 6 hours to remove redundant humidity; placing the green aeration stone inside a baking oven at a temperature of 105° C. for 6 hours; and firing the green aeration stone inside a high-temperature furnace to raise the temperature thereof from the ambient temperature to 1000° C. Refer to FIG. 4A, which is a diagram showing a heating curve of the firing process of the green aeration stone. As the reaction temperature of ferric oxide is higher, the green aeration stone is heated at a higher speed in the initial stage. When the temperature is over 700° C., the heating speed is decreased to prevent the ferric-oxide foaming agent from reacting too fast. When the temperature reaches 1000° C., the green aeration stone is maintained at the temperature for 2 hours. The firing time varies according to the application of the aeration stone. When the aeration stone does not lay emphasis on hardness but is only used for aeration, the green aeration stone can be fired according to the heating curve shown in FIG. 4B to shorten the firing time. Therefore, the aeration stone fired according to the heating curve shown in FIG. 4A has a higher hardness and durability comparatively.

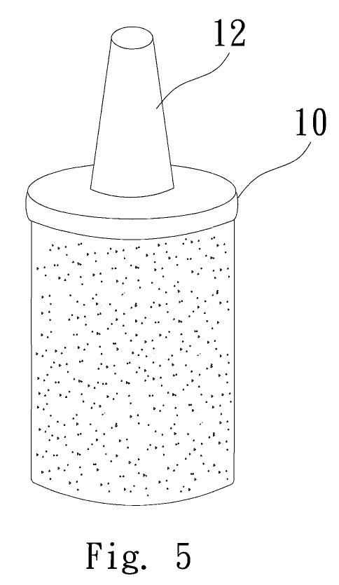

Next in Step S8, the fired aeration stone is cooled down. Thus, a porous aeration stone is attained. Next in Step S9, a hole is drilled on the aeration stone, and a connector is installed in the hole. Thus, a finished aeration stone 10, as shown in FIG. 5, is completed.

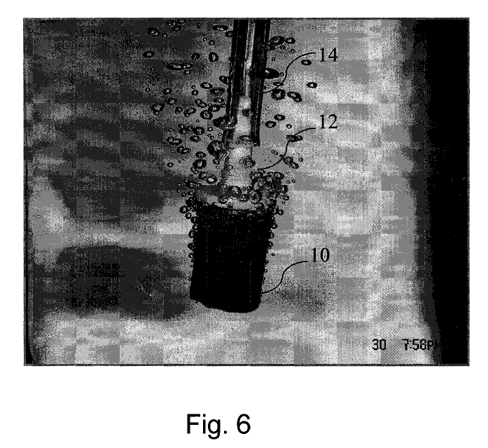

Refer to FIG. 6, which is a diagram showing the application of the aeration stone according to the present invention. The connector 12 of the aeration stone 10 is coupled to the terminal of the duct 14 of an air generator, and the aeration stone 10 is immersed in water. When the air generator operates, air will be released from the porous wall of the aeration stone 10; thus, many tiny bubbles are generated.

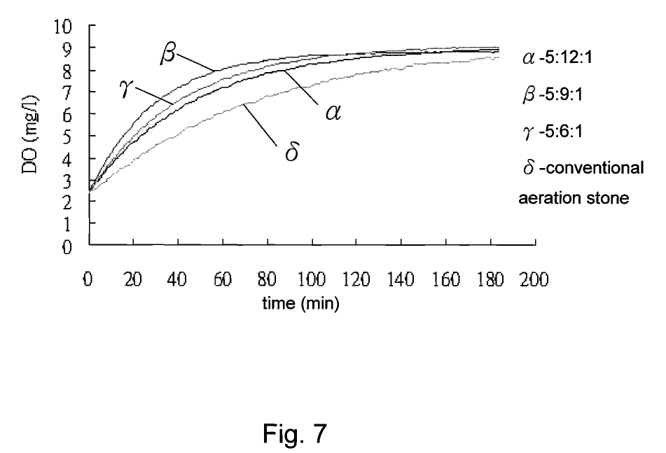

Refer to FIG. 7, which is a diagram showing the dissolved-oxygen curves of a conventional aeration stone and the aeration stones fabricated with the method of the present invention according to three different ratios of the abandoned activated sludge, red soil and alkaline metal oxide, wherein the dissolved-oxygen content is measured in a 20-L container, and the aeration rate of each aeration stone is 0.5 L/min. Curves α, β, γ denote the dissolved-oxygen contents of the aeration stones fabricated with the method of the present invention according to the ratios of the abandoned activated sludge, red soil and alkaline metal oxide 5:12:1, 5:9:1 and 5:6:1 respectively; Curve δ denotes the dissolved-oxygen content of a conventional aeration stone.

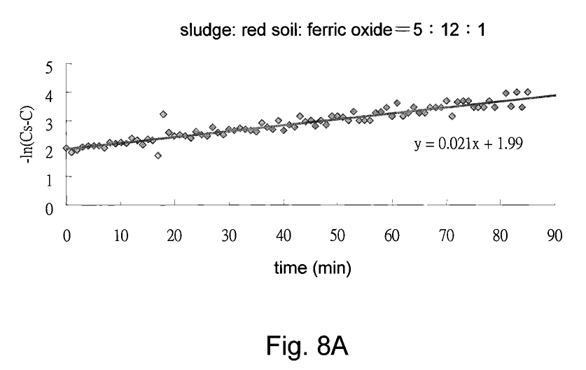

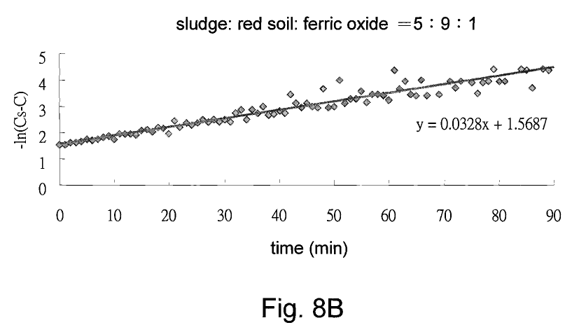

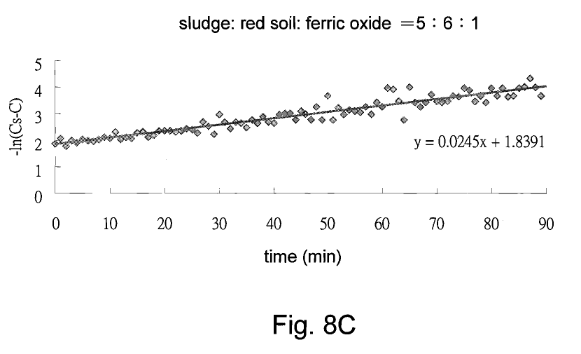

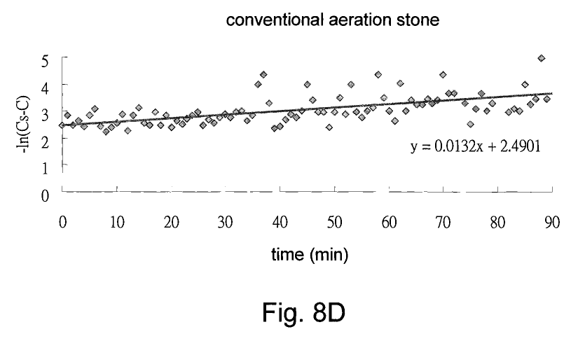

Refer to FIG. 8A, FIG. 8B, FIG. 8C and FIG. 8D, which are diagrams showing the oxygen transference coefficients of the conventional aeration stone and the aeration stones fabricated with the method of the present invention according to three different ratios, wherein the oxygen transference coefficients are based on the data shown in FIG. 7. The slope “a” of the equation y=ax+b is the oxygen transference coefficient. The greater the oxygen transference coefficient, the better the effect of aeration. From FIG. 8A, FIG. 8B and FIG. 8C, it is known that the oxygen transference coefficients of the aeration stones fabricated with the method of the present invention according to the ratios of the abandoned activated sludge, red soil and alkaline metal oxide 5:12:1, 5:9:1 and 5:6:1 are respectively 0.021, 0.0328 and 0.0245. From FIG. 8D, it is known that the oxygen transference coefficient of the conventional aeration stone is 0.0132. From the foregoing discussion, it is known that the oxygen transference coefficients of the aeration stones fabricated with the method of the present invention are greater than that of the conventional aeration stone, and that the aeration stone fabricated according to the ratio of the abandoned activated sludge, red soil and alkaline metal oxide 5:9:1 has a higher oxygen transference coefficient, i.e. has a better aeration effect than other aeration stones.

As the objective of the present invention is to recycle abandoned activated sludge, it is expected that abandoned activated sludge can be consumed as much as possible. Therefore, the ratio of abandoned activated sludge, red soil and an alkaline metal oxide can be adjusted to be 5:8:1 to increase the consumption of abandoned activated sludge. Besides, the compression strength of the aeration stone of the present invention is about 56.15 kgf/cm².

In summary, the present invention proposes a method for fabricating an aeration stone, wherein the abandoned sludge of wastewater treatment works is used as the main material of aeration stones, and whereby abandoned sludge can be recycled, and environmental pollution can be reduced, and an aeration stone with a superior aeration effect can be attained.

Those described above are the preferred embodiments to exemplify the technical thought and characteristics of the present invention to enable the persons skilled in the art to understand, make and use the present invention. However, it is not intended to limit the scope of the present invention. Any equivalent modification or variation according to the spirit of the present invention is to be also included within the scope of the present invention.

What is claimed is:

1. A method for fabricating an aeration stone, comprising the following steps:
separately drying abandoned activated sludge, red soil and an alkaline metal oxide, and separately cracking said abandoned activated sludge, red soil and alkaline metal oxide;
separately sieving the cracked said abandoned activated sludge, red soil and alkaline metal oxide to obtain smaller grains thereof, and separately grinding said grains into fine particles;
mixing said fine particles of said abandoned activated sludge, red soil and alkaline metal oxide into a mixture, and molding said mixture into a green aeration stone;
firing said green aeration stone; and
cooling down said green aeration stone to obtain an aeration stone.

2. The method for fabricating the aeration stone according to claim 1, further comprising a step of drilling a hole on said aeration stone.

3. The method for fabricating the aeration stone according to claim 2, wherein a connector for coupling to a duct is installed in said hole.

4. The method for fabricating the aeration stone according to claim 1, wherein said alkaline metal oxide is ferric oxide.

5. The method for fabricating the aeration stone according to claim 1, wherein said abandoned activated sludge, red soil and alkaline metal oxide are dried at a temperature of between 80 and 120° C.

6. The method for fabricating the aeration stone according to claim 1, wherein the sieved said grains have a diameter of less than 0.3 mm.

7. The method for fabricating the aeration stone according to claim 1, wherein said fine particles have a diameter of less than 10 μm.

8. The method for fabricating the aeration stone according to claim 1, wherein said fine particles of said abandoned activated sludge, red soil and alkaline metal oxide are mixed by a weight ratio of between 5:6:1 and 5:12:1.

9. The method for fabricating the aeration stone according to claim 1, wherein water is added to said mixture during mixing said fine particles of said abandoned activated sludge, red soil and alkaline metal oxide.

10. The method for fabricating the aeration stone according to claim 1, wherein the step of firing said green aeration stone further comprises the following steps:
air drying said green aeration stone;
placing said green aeration stone inside a freezing device to remove redundant humidity;
placing said green aeration stone inside a baking oven to dry said green aeration stone; and
heating said green aeration stone to a high temperature.

11. The method for fabricating the aeration stone according to claim 10, wherein said green aeration stone is air dried for 10 minutes.

12. The method for fabricating an aeration stone according to claim 10, wherein said green aeration stone is placed inside said freezing device for 6 hours.

13. The method for fabricating the aeration stone according to claim 10, wherein said green aeration stone is placed inside said baking oven at a temperature of 105° C. for 6 hours.

14. The method for fabricating the aeration stone according to claim 10, wherein said green aeration stone is heated from the ambient temperature to 1000° C.
